(19) United States
(12) Patent Application Publication
(10) Pub. No.: US 2016/0341297 A1
(43) Pub. Date: Nov. 24, 2016

(54) BEVEL GEAR POWER TRANSMISSION STRUCTURE

(71) Applicant: KANZAKI KOKYUKOKI MFG. CO., LTD., Amagasaki-shi (JP)

(72) Inventors: Koji IWAKI, Amagasaki-shi (JP); Jun Matsuura, Amagasaki-shi (JP); Toshifumi Yasuda, Amagasaki-shi (JP)

(21) Appl. No.: 15/159,456

(22) Filed: May 19, 2016

(30) Foreign Application Priority Data
May 20, 2015 (JP) 2015-102650

(51) Int. Cl. F16H 57/038; F16H 1/14; F16H 57/021

(52) U.S. Cl. CPC F16H 57/038; F16H 57/021; F16H 1/14

(57) ABSTRACT

In a bevel gear power transmission structure of the present invention, a first wall of a gear box, supporting a first shaft that is one of a drive shaft and a driven shaft, has a first opening having a larger diameter than a first bevel gear that is supported by the first shaft, and a hollow first collar retaining a first bearing that supports the first shaft is detachably disposed in the first opening. The first collar has an engagement surface facing outward in an axial direction of the first shaft in the first opening, and the engagement surface is directly or indirectly engaged with a first-collar retaining ring detachably attached to the inner circumferential surface of the first opening so that the first collar is prevented from being separated outward from the first opening.

### BACKGROUND OF THE INVENTION

Field of the Invention

The present invention relates to a bevel gear power transmission structure for transmitting power via a bevel gear train from a drive shaft to a driven shaft that arc disposed perpendicular to each other.

Related Art

Bevel gear power transmission structures for transmitting power via a bevel gear train from a drive shaft to a driven shaft that are disposed perpendicular to each other are used in a broad range of utility vehicles such as tractors and riding lawn mowers (see, for example, a microfilm of Japanese Utility Model Application No. S53-160976 (Japanese Unexamined Utility Model Application Publication No. S55-076929), which will be referred to as Patent Document 1 below).

Such bevel gear power transmission structures nave a drive shaft, a driven shaft, a gearbox supporting the drive shaft and the driven shaft via bearings such that the drive shaft and the driven shaft are perpendicular to each other, a drive-side bevel gear supported by the drive shaft so as to be placed in the gearbox, and a driven-side bevel gear supported by the driven shaft so as to mesh with the drive-side bevel gear in the gearbox.

The conventional bevel gear power transmission structure described in Patent Document 1 employs the following configuration to support the drive shaft in a rotatable manner around the axis while placing the drive-side bevel gear supported by the drive shaft in the gearbox.

The gear box has a wall that supports the drive shaft and that has an opening having a larger diameter than the drive-side bevel gear, and a hollow collar is detachably attached to the opening.

Specifically, the collar has a cylindrical part disposed in the opening and retaining a bearing rotatably supporting the drive shaft and a flange extending radially outward from the cylindrical part along the outer surface of the wall of the gearbox, and the collar is detachable attached to the wall by bolts provided through fastening holes formed in the flange.

In the above-described conventional configuration, an arrangement of the hollow collar enables the drive-side bevel gear supported by the drive shaft to be placed in the gearbox and the drive shall to be supported by the bearing so as to be rotatable around the axis. The flange extending radially outward from the cylindrical part that is disposed in the opening is connected to the wall of the gearbox by fasteners to fix the collar in place. Consequently, the presence of the flange results in a large collar size and, at the same time, space for the attachment and detachment work for the fasteners has to be secured in the vicinity of the flange, thus posing the problem that the overall size of the bevel gear power transmission structure is also large.

Moreover, in order for optimum meshing between the drive-side bevel gear and the driven-side bevel gear, it is necessary to adjust the positions of the bevel gears in their axial directions. Specifically, the position of each bevel gear in the axial direction is adjusted by interposing a shim having a suitable thickness between the bevel gear and the corresponding bearing.

For this adjustment work, the collar needs to be detached, and in the above-described conventional configuration in which the collar is attached to the gearbox by bolts, the detachment and attachment work for the collar is extremely troublesome.

### SUMMARY OF THE INVENTION

the present invention has been conceived in view of the conventional art described above, and an object of the present invention is to provide a bevel gear power transmission structure for transmitting power via a bevel gear train from a drive shaft to a driven shaft disposed perpendicular to each other, which can be reduced in size and facilitate the replacement of shims used for adjusting the bevel gear positions.

In order to achieve the object, the present invention provides a bevel gear power transmission structure for transmitting rotative power from a drive shaft to a driven shaft, including the drive shaft, a gearbox supporting the drive shaft via a drive-side bearing so as to be rotatable around an axis, a drive-side bevel gear supported by the drive shaft so as to be placed in an inner space of the gearbox, the driven shaft supported by the gearbox via a driven-side bearing so as to be perpendicular to the drive shaft and rotatable around an axis, and a driven-side bevel gear supported by the driven shaft so as to mesh with the drive-side bevel gear in the inner space of the gearbox, wherein a first wall of the gear box, supporting a first shaft that is one of the drive shaft and the driven shaft, has a first opening having a larger diameter than a first bevel gear that is one of the drive-side bevel gear and the driven-side bevel gear and that is supported by the first shaft, a hollow first collar retaining a first bearing that is one of the drive-side bearing and the driven-side bearing and that supports the first shaft is detachably disposed in the first opening, and the first collar has an outer circumferential surface in contact with an inner circumferential surface of the first opening, an inner circumferential surface in contact with an outer ring of the first bearing, and an engagement surface facing outward in an axial direction of the first shaft in the first opening; the engagement surface is directly or indirectly engaged with a first-collar retaining ring detachably attached to the inner circumferential surface of the first opening; and the first collar is thereby prevented from being separated outward from the first opening.

The thus configured bevel gear power transmission structure makes it possible to reduce a whole size of the transmission structure and facilitate a replacement work of a shim that is used for adjusting a position of the first bevel gear.

Preferably, the first collar may have a large-diameter past forming the outer circumferential surface in contact with the inner circumferential surface of the first opening, and a small-diameter part that has a diameter smaller than the large-diameter part with the engagement surface being interposed between the large-diameter part and the small-diameter part and that extends outward in the axial direction of the first shaft.

An outer circumferential surface of the small-diameter part has a depressed or projecting first-collar-side engagement part depressed radially inward or projecting radially outward with reference to an axis of the first shaft, a portion of the first opening corresponding to the small-diameter part in the axial direction of the first shaft have a depressed or projecting first-opening-side engagement part depressed radially outward or projecting radially inward with reference to the axis of the first shaft.

An engagement member having engagement parts respectively engaged with the first-collar-side engagement part and the first-opening-side engagement part is interposed between the engagement surface and the first-collar retaining ring.

In a configuration where the first bevel gear is supported by the first shaft in a relatively non-rotatable manner around the axis and in a movable manner in the axial direction with respect to the first shaft, an inner ring of the first bearing has an end surface facing inward in the axial direction of the first shaft and directly or indirectly in contact with a back surface of the first bevel gear, and an outer ring of the first bearing has an end surface facing outward in the axial direction of the first shaft, and directly or indirectly in contact with a bearing retaining ring detachably attached to the inner circumferential surface of the first collar, a shim may be interposed at least between the hack, surface of the first bevel gear and the inner ring of the first bearing or between the outer ring of the first bearing and the bearing retaining ring.

In any one of the above-mentioned various configurations, the gearbox is configured

to have the first wall, a second wall lacing the first wall, a third wall supporting a second shaft that is the other one of the drive shaft and the driven shaft via a second bearing that is the other one of the drive-side bearing and the driven-side bearing, and a fourth wall facing the third wall.

In one embodiment the first shaft, is supported at two portions that includes a first portion supported by the first wall via the first bearing and a second portion supported by the second wall via a bearing, the third wall has a second opening through which the second shaft is disposed via the second bearing, and the fourth wall has an access opening having a larger diameter than a second bevel gear that is the other one of the drive-side bevel gear and the driven-side bevel gear and that is supported by the second shaft. The access opening is blocked by a cap detachably attached thereto.

In another embodiment, the first shaft is supported at two portions that includes a first portion supported by the first wall via the first bearing and a second portion supported by the second wall via a bearing, the third wall has a second opening having a larger diameter than a second bevel gear that is the other one of the drive-side bevel gear and the driven-side bevel gear and that is supported by the second shaft. The hollow second collar retaining the second bearing is detachably disposed in the second opening.

The second collar has an outer circumferential surface in contact with an inner circumferential surface of the second opening, an inner circumferential surface in contact with an outer ring of the second bearing, and an engagement surface facing outward in an axial direction of the second shaft in the second opening; and the second collar is prevented from being separated outward from the second opening by a second-collar retaining ring detachable attached to the second opening so as to he directly or indirectly engaged with the engagement surface.

### BRIEF DESCRIPTION OF THE DRAWINGS

The above, and other objects, features and advantages of the present invention will become apparent from the detailed description thereof in conjunction with the accompanying drawings therein.

FIG. 1A and FIG. 1B are a side view and a bottom view, respectively, of a riding lawn mower that is one example of a utility vehicle to which a bevel gear power transmission structure according to one embodiment of the present invention is applied.

FIG. 2A and FIG. 2B are a side view and a bottom view, respectively, of a tractor that is another example of the utility vehicle to which the bevel gear power transmission structure according to one embodiment of the present invention is applied.

FIG. 3 is a vertical cross-sectional view of the bevel gear power transmission

structure taken along the line III-III in FIG. 1B.

FIG. 4 is a plan view of the bevel gear power transmission structure.

FIG. 5 is a partially exploded perspective view in the vicinity of a first opening formed in a first wall of a gear box in the bevel gear power transmission structure.

FIG. 6 is an exploded vertical cross-sectional view of the bevel gear power transmission structure.

FIGS. 7A and 7B are a partial vertical cross-sectional view and a partial exploded vertical cross-sectional view, respectively, of a bevel gear power transmission structure according to a first modification.

FIG. 8 is a vertical cross-sectional view of a bevel gear power transmission structure according to a second modification.

### DETAILED DESCRIPTION OF THE PREFERRED EMBODIMENTS

Below, one embodiment of the bevel gear power transmission structure of the present invention will now be described with reference to the appended drawings.

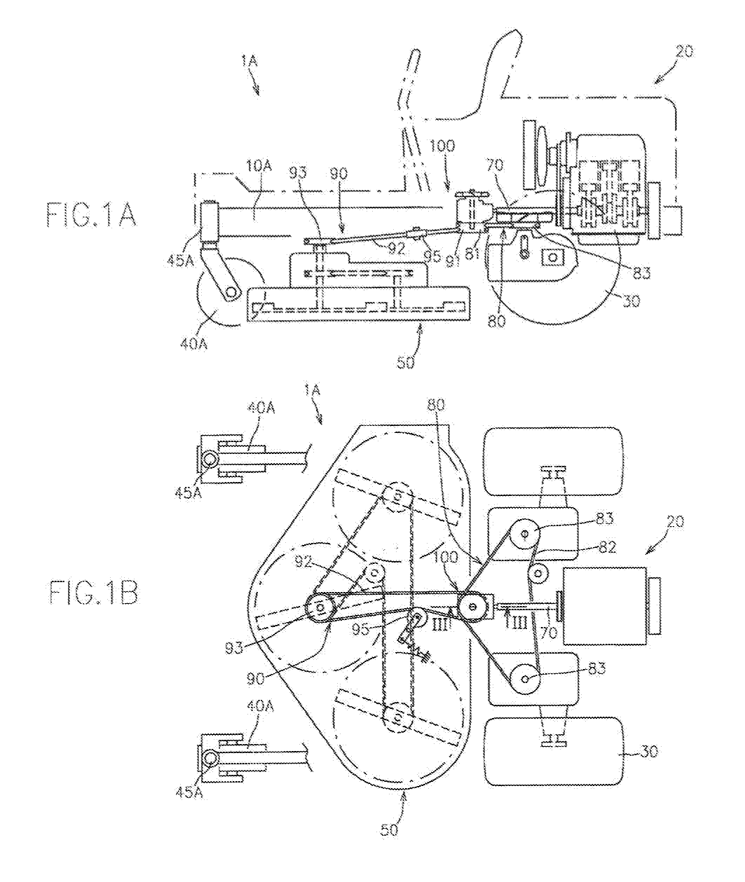

FIG. 1A and FIG. 1B show a side view and a bottom view, respectively, of a riding lawn mower 1A that is one example of a utility vehicle to which a bevel gear power transmission structure 100 of this embodiment is applied.

The utility vehicle 1A in the form of a riding lawn mower includes a vehicle frame 10A, a drive source 20 supported by the vehicle frame 10A, drive wheels 30 supported by the vehicle frame 10A, auxiliary-wheel frames 45A supported substantially vertically by the vehicle frame 10A so as to be rotatable around the axis, auxiliary wheels 40A supported by the auxiliary-wheel frames 45A so as to be rotatable around a substantially horizontal hub, and a working device 50 supported by the vehicle frame 10A.

The bevel gear power transmission structure 100 is provided in a power transmission path for transmitting rotative power from the drive source 20 to the drive wheels 30 and the working device 50.

Specifically, the utility vehicle 1A has a common power transmission path 70 for transmitting rotative power from the drive source 20 to the bevel gear power transmission structure 100, a travel-system power transmission path 80 for transmitting rotative power from the bevel gear power transmission structure 100 to the drive wheels 30, and a working-system power transmission path 90 for transmitting rotative power from the bevel gear power transmission structure 100 to the working device 50.

In this embodiment, the common power transmission path 70 has a power transmission shaft for operatively coupling the output shaft of the drive source 20 to a drive shaft 110 of the bevel gear power transmission structure 100.

The travel-system power transmission path 80 has a travel-system drive pulley 81 supported by a driven shaft 120 of the bevel gear power transmission structure 100 in a relatively non-rotatable manner with respect to the drive shaft 120, right-and-left travel-system driven pulleys 83 operatively connected to transaxles that drive the driving wheels 30, respectively, and a travel-system belt 82 wound around the travel-system drive pulley 81 and the travel-system driven pulleys 83.

The working-system power transmission path 90 has a working-system drive pulley 91 supported by the driven shaft 120 of the bevel gear power transmission structure 100 in a relatively non-rotatable manner with respect to the driven shaft 120, a working-system driven pulley 93 operatively connected to the working device 50, and a working-system belt 92 wound around the working-system drive pulley 91 and the working-system driven pulleys 93.

Reference number 95 in FIG. 1A and FIG. 1B indicates a clutch for changing the power transmission state of the working-system power transmission path 90.

Naturally, the bevel gear power transmission structure 100 may be suitably used in other utility vehicles than riding lawn mowers.

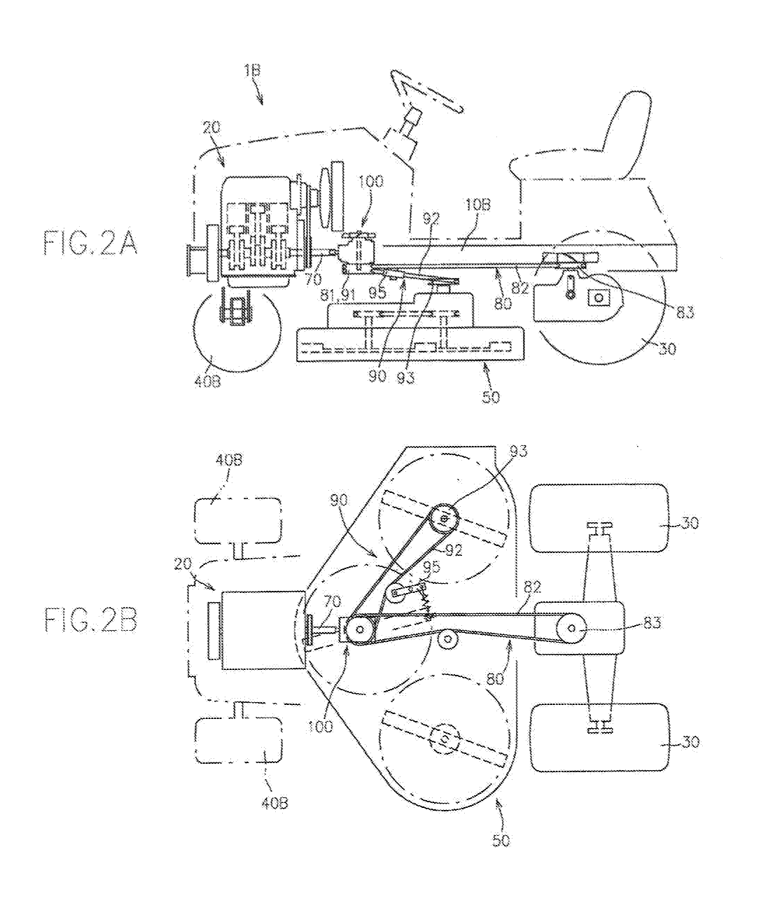

FIG. 2 and FIG. 2B show a side view and a bottom view, respectively, of a tractor 1B that is another example of a utility vehicle to which the bevel gear power transmission structure 100 may be applied.

The utility vehicle 1B in the form of a tractor includes a vehicle frame 10B, a drive source 20 supported by the vehicle frame 10B, drive wheels 30 supported by the vehicle frame 10B, steered wheels 40B supported by the vehicle frame 10B, and a working device 50 supported by the vehicle frame 10B, wherein the bevel gear power transmission structure 100 is provided in the power transmission path for transmitting rotative power from the drive source 20 to a single travel-system driven pulley 83 operatively connected to a common transaxle for driving the drive wheels 30 and to a working-system driven pulley 93 operatively connected to the working device 50.

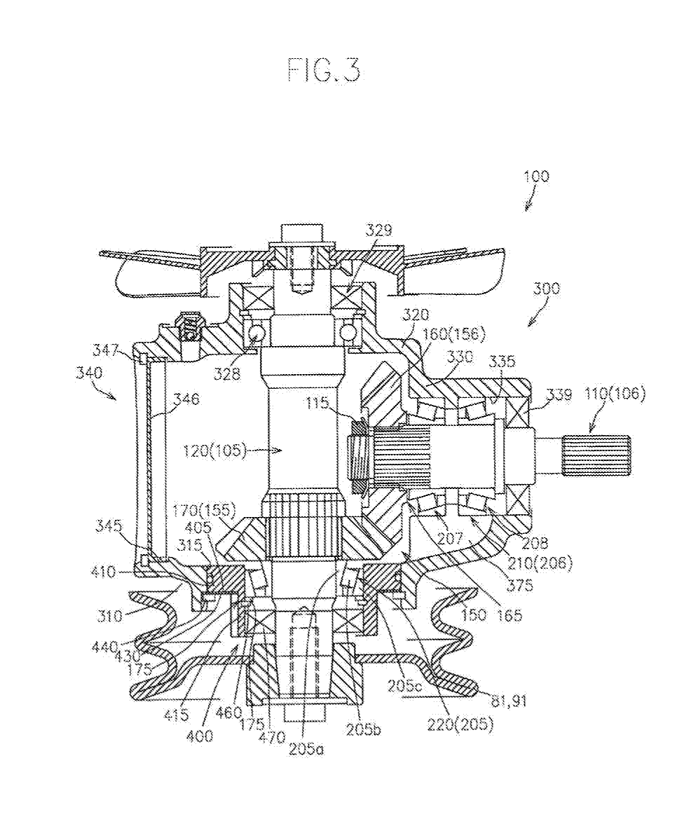

FIG. 3 shows a vertical cross-sectional view of the bevel gear power transmission structure 100 taken along the line III-III in FIG. 1B.

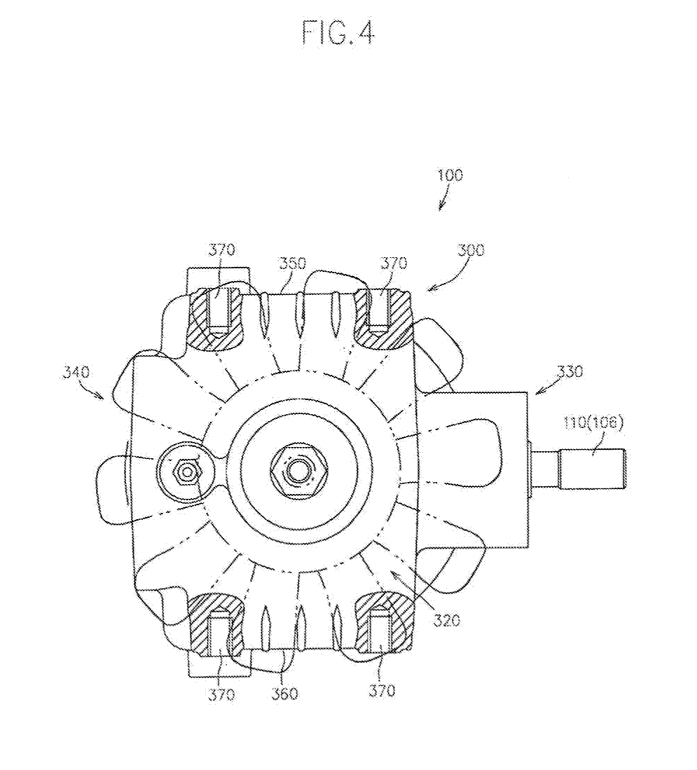

FIG. 4 shows a plan view of the bevel gear power transmission structure 100.

The bevel gear power transmission structure 100 is configured to transmit rotative power via a bevel gear train 150 from the drive shaft 110, which is operatively connected to the drive source 20, to the driven shaft 120 placed perpendicular to the drive shaft 110.

Specifically, the bevel gear power transmission structure 100 includes the drive shaft 110, a gearbox 300 supporting the drive shaft 110 via a drive-side bearing 210 so as to be rotatable around the axis, a drive-side bevel gear 160 supported by the drive shaft 110 so as to be placed in the inner space of the gearbox 300, a driven shaft 120 supported by the gearbox 300 via a driven-side bearing 220 so as to be perpendicular to the drive shall 110 and rotatable around the axis, and a driven-side bevel gear 170 supported by the driven shall 120 so as to mesh with the drive-side bevel gear 160 in the inner space of the gearbox 300 to form the bevel gear train 150.

In this embodiment, as shown in FIG. 3, the drive shaft 110 is placed in a substantially horizontal manner, and the driven shaft 120 is placed in a substantially vertical manner. Naturally, the present invention is not limited to such a configuration as long as the drive shaft 110 and the driven shaft 120 arc placed perpendicular to each other.

Meanwhile, as in this embodiment, in the case where rotative power is transmitted via the bevel gear train 150, it is necessary to adjust the positions in the axial directions of the bevel gears (the drive-side bevel gear 160 and the driven-side bevel gear 170) constituting the bevel gear train 150 to achieve the optimal meshing state of the bevel gear train 150 and, in general, the positions of the bevel gears 160 and 170 in their axial directions are adjusted by placing shims each having an optimal thickness.

That is, adjustment work is performed such that the bevel gear power transmission structure 100 is assembled in which shims having predetermined thicknesses are provided respectively for the bevel gears 160 and 170; the meshing state of the bevel gear train 150 is checked; if the meshing state is not favorable, the shims are replaced with other shims having different thicknesses; the bevel gear power transmission structure 100 is assembled in winch the positions of the bevel gears 160 and 170 in the axial directions are changed; and then the meshing state of the bevel gear train 150 is checked.

The bevel gear power transmission structure 100 according to this embodiment has the following configuration to facilitate such shim replacement work and reduce the overall size of the structure.

As shown in FIG. 3, in the bevel gear power transmission structure 100 according to this embodiment, the gear box 300 has a first wall 310 supporting a first shaft 105 that is one of the drive shaft 110 and the driven shaft 120, and the first wall 310 has a first opening 315 having a larger diameter than a first bevel gear 155 that is one of the drive-side bevel gear 160 and the driven-side bevel gear 170 and that is supported by the first shaft 105.

In this embodiment, the driven shaft 120 corresponds to the first shaft 105. Accordingly, the driven-side bevel gear 170 corresponds to the first bevel gear 155, and the first opening 315 has a larger diameter than the driven-side bevel gear 170.

As shown in FIG. 3, a hollow first collar 400 retaining a first bearing 205 (the driven-side bearing 220 in this embodiment) that is one of the bearings supporting the first shaft (the driven shaft 120 in this embodiment) is detachably disposed in the first opening 315.

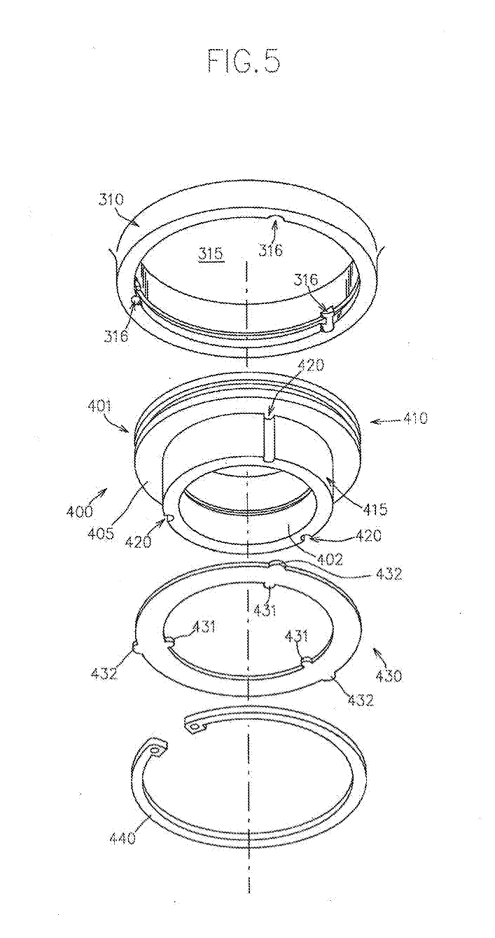

FIG. 5 shows a partially exploded perspective view in the vicinity of the first opening 315.

As shown in FIG. 5, the first collar 400 is in a hollow shape and has an outer circumferential surface 401 that comes into contact with the inner circumferential surface of the first opening 315 and an inner circumferential surface 402 that comes into contact with the outer ring of the first bearing 205.

The first bearing 205 has an inner ring 205a, an outer ring 205c surrounding the inner ring 205a, and rolling elements 205b interposed between the inner ring 205a and the outer ring 205c.

As shown in FIG. 3, when the inner ring 205a is disposed around the first shaft 105, the end surface facing inward in the axial direction of the first shaft 105 is directly or indirectly in contact with the back surface of the first bevel gear 155.

When the outer ring 205c is disposed in the hollow part of the first collar 400 such that the outer circumferential surface is in contact with the inner circumferential surface 402 of the first collar 400, the end surface facing outward in the axial direction of the first shaft 105 is directly or indirectly in contact with a bearing retaining ring 460 detachably attached to the Inner circumferential surface 402 of the first collar 400.

In this configuration, a shim 175 having a predetermined thickness is interposed at least between the back surface of the first bevel gear 155 and the inner ring 205a of the first bearing 205 or between the outer ring 205c of the first bearing 205 and the bearing retaining ring 460 to place the first bevel gear 155 into an optimal position in the axial direction.

In this embodiment, as shown in FIG. 3, the shim 175 is interposed between the outer ring 205c of the first bearing 205 and the bearing retaining ring 460.

In this embodiment, the first bearing 205 is a tapered roller bearing.

As shown in FIGS. 3 and 5, the first collar 400 has an engagement surface 405 lacing outward in the axial direction of the first shaft 105 in the first opening 315; a first-collar retaining ring 440 detachably attached to the inner circumferential surface of the first opening 315 is directly or indirectly engaged with the engagement surface 405; and the first collar 400 is thereby prevented from being separated outward from the first opening 315.

The bevel gear power transmission structure 100 with the above-described configuration can have a smaller size than power transmission structures with conventional configurations, and facilitate the replacement work for the shim 175 due to the easy detachment and attachment work for the first collar 400.

These effects will now he explained in comparison with conventional bevel gear power transmission structures.

Conventional bevel gear power transmission structures (conventional configurations) include a drive shaft, a gearbox supporting the drive shaft via a drive-side bearing so as to be rotatable around the axis, a drive-side bevel gear supported by the drive shaft so as to be placed in the inner space of the gearbox, a driven shaft supported by the gearbox via a driven-side bearing so as to be perpendicular to the drive shaft and rotatable around the axis, and a driven-side bevel gear supported by the driven shaft so as to mesh with the drive-side bevel gear in the inner space of the gearbox, wherein the gearbox has a wall that supports one of the drive shall and the driven shaft and that has an opening having a larger diameter than the bevel gear supported by said one shaft, and a collar for retaining the bearing supporting said one shaft so as to be rotatable around the axis is attached to the opening.

The collar used in the conventional configuration has a cylindrical part disposed in the opening and retaining the bearing for rotatably supporting said one shaft and a flange extending radially outward from the cylindrical part along the outer surface of the wall of the gearbox. The collar is detachably attached to the wall by bolts provided through fastening holes formed in the flange.

In the conventional configuration described above, the flange of the collar results in a large collar size and, at the same time, space for the attachment and detachment work for fasteners has to be secured in the vicinity of the flange, thus posing the problem that the overall bevel gear transmission structure is also large.

Moreover, when attaching or detaching the collar, the fasteners have to be fastened or removed, thus making the attachment and detachment work for the collar extremely troublesome.

On the other hand, in this embodiment, as described above, the engagement surface 405 is directly or indirectly engaged with the first-collar retaining ring 440 detachably attached to the inner circumferential surface of the first opening 315, and the collar 400 is thereby prevented from being separated from the first opening 315. Accordingly, it is possible to reduce the size of the collar 400 and the space for the attachment and detachment work for the collar 400 unnecessary.

These effects are particularly beneficial to a configuration in which the pulleys 81 and 91 are attached to the first shaft 105 as in this embodiment.

In this embodiment, the travel-system drive pulley 81 and the working-system drive pulley 91 are integrated into a single body.

Moreover, this embodiment facilitates the attachment and detachment work for the first collar 400 and enables the replacement work for the shim 175 to be performed in an efficient manner.

In this embodiment, as shown in FIGS. 3 and 5, the first collar 400 has a large-diameter part 410 forming the outer circumferential surface 401 in contact with the inner circumferential surface of the first opening 315 and a small-diameter part 415 that has a diameter smaller than the large-diameter part 410 with the engagement surface 405 being interposed between them and extends outward in the axial direction of the first shaft 105.

The outer circumferential surface of the small-diameter part 415 has depressed or projecting first-collar-side engagement parts 420 depressed radially inward or projecting radially outward with reference to the axis of the first shaft 105.

As shown in FIG. 5, in this embodiment, the first-collar-side engagement parts 420 are depressed.

On the other hand, portions of the first opening 315 corresponding to the small-diameter parts 415 in the axial direction of the first shaft 105 have depressed or projecting first-opening-side engagement parts 316 depressed radially outward or projecting radially inward with reference to the axis of the first shaft 105.

As shown in FIG. 5, in this embodiment, the first-opening-side engagement parts 316 are depressed.

In the bevel gear power transmission structure 100 according to this embodiment, an engagement member 430 having engagement parts 431 and 432 respectively engaged with the first-collar-side engagement parts 420 and the first-opening-side engagement parts 316 is interposed between the engagement surface 405 and the first-collar retaining ring 440.

The engagement member 430 can effectively prevent the first collar 400 from rotating around the axis.

In this embodiment, the engagement member 430 is in a ring shape.

In this embodiment, as shown in FIG. 3, an oil seal 470 is provided in the hollow part of the first collar 400 so as to be located more toward the outside in the axial direction of the first shaft 105 than the bearing retaining ring 460 is.

As shown in FIGS. 3 and 4, in this embodiment, the gearbox 300 is in a substantially cuboidal shape and has, in addition to the first wall 310 supporting the first shaft 105 via the first bearing 205, a second wall 320 facing the first wall 310, a third wall 330 supporting a second shaft 106 that is the other one of the drive shaft 110 and the driven shaft 120 (the drive shaft 110 in this embodiment) via the second bearing 206 that is the other one of the drive-side bearing 210 and the driven-side bearing 220 (the drive-side bearing 210 in this embodiment), a fourth wall 340 facing the third wall 330, a fifth wall 350 blocking one side of the space defined by the first to fourth walls 310 to 340 (one side in the vehicle width direction in this embodiment), and a sixth wall 360 blocking the other side of the space defined by the first to fourth walls 310 to 340 (the other side in the vehicle width direction in this embodiment).

In this embodiment, the gearbox 300 is fixed to the vehicle frame 10A via screw holes 370 (see FIG. 4) formed in the fifth wall 350 and the sixth wall 360.

As shown in FIG. 3, in this embodiment, the respective ends of the first shaft 105 are supported by the first wall 310 and the second wall 320 and, on the other hand, the second shaft 106 is supported by the third wall 330 in a cantilever manner.

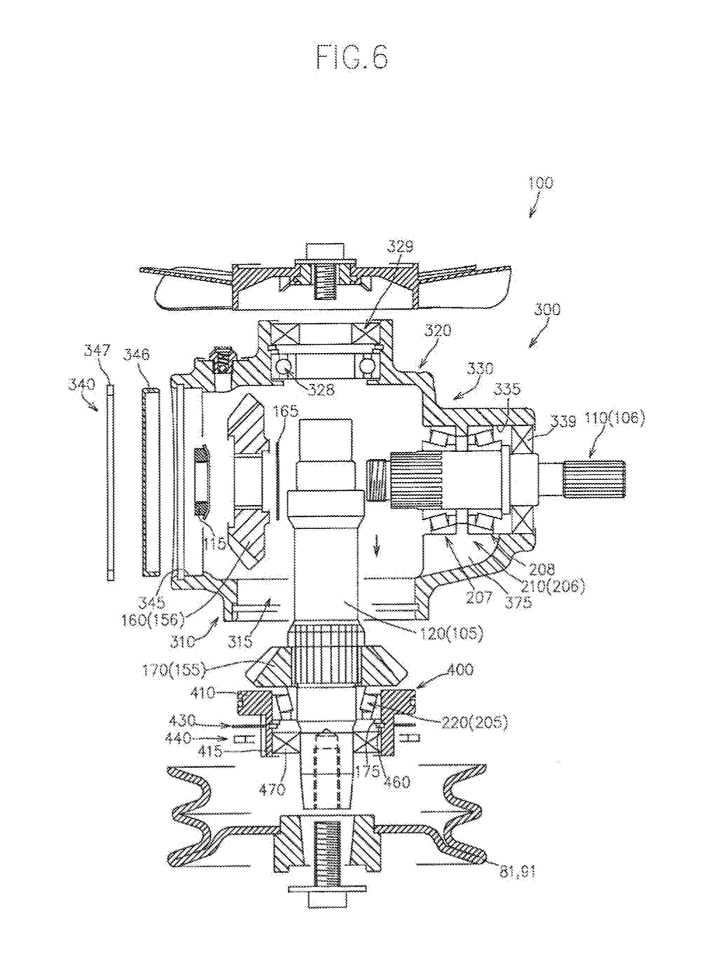

FIG. 6 shows an exploded vertical cross-sectional view of the bevel gear power transmission structure 100.

Specifically, as shown in FIGS. 3 and 6, the first shaft 105 is supported by the first wall 310 via the first bearing 205 and, at the same time, supported by the second wall 320 via another bearing 328.

Reference number 329 in FIGS. 3 and 6 indicates an oil seal that is provided in the second wall 320 so as to be located more toward the outside in the axial direction of the first shaft 105 than the bearing 328 is.

The second shaft 106 is supported by the second opening 335 formed in the third wall 330 via the second bearing 206 so as to be rotatable around the axis.

In this embodiment, the second opening 355 has a smaller diameter than the second bevel gear 156 (the drive-side bevel gear 160 in this embodiment) supported by the second shaft 106, and the second bevel gear 156 is accommodated in the gearbox 300 via an access opening 345 that is formed in the fourth wall 340 and that has a larger diameter than the second bevel gear 156.

The installation of the second shaft 106 and the second bevel gear 156 in the gearbox 300 is performed as follows.

In this embodiment, as shown in FIGS. 3 and 6, the second bevel gear 156 is spline-coupled to the second shaft 106 so as to be incapable of relative rotation around the axis and movable in the axial direction.

In this configuration, Initially, the second shaft 106 is supported by the second opening 335 via the second bearing 206.

In this state, the second bevel gear 156 is inserted into the gearbox 300 through the access opening 345 to be disposed around and spline-coupled to the second shaft 106.

When disposing the second bevel gear 156 around the second shaft 106, moving the first shaft 105 in the direction from the second wall 320 toward the first wall 310 (the direction indicated by the arrow in FIG. 6) ensures space where the second bevel gear 156 is passed through.

In this embodiment, as shown in FIGS. 3 and 6, the second bearing 206 has an inner second bearing 207 and an outer second bearing 208 respectively placed on the near side and the far side relative to the inner space of the gearbox 300 in the axial direction of the second shaft 106.

A shim 165 for adjusting the position in the axial direction of the second bevel gear 156 is interposed between the back surface of the second bevel gear 156 and the inner ring of the inner second bearing 207.

That is, when it is desired to position, the second bevel gear 156 more toward the center of the gearbox 300 (to the left in FIGS. 3 and 6), a thicker shim is used as the shim 165. On the other hand, when it is desired to position the second bevel gear 156 more toward the outside of the gearbox 300 (to the right in FIGS. 3 and 6), a thinner shim is used as the shim 165.

In FIGS. 3 and 6, reference number 115 indicates a nut screwed onto the second shaft 106 for preventing the movement of the second bevel gear 156 toward the center of the gearbox 300, and reference number 339 indicates an oil seal provided in the third wall 330 so as to be located snore toward the outside in the axial direction of the second shaft 106 than the outer second bearing 208 is.

Reference number 346 indicates a cap for blocking the access opening 345, and reference number 347 indicates a retaining ring for preventing the cap 346 from being separated.

As in this embodiment, in a configuration where a tapered roller bearing is used as the second bearing 206, oil in the gearbox 300 is sent outward as the second bearing 206 is rotated.

Concerning this point, in this embodiment, as shown in FIGS. 3 and 6, a part of the inner circumferential surface of the second opening 335 is formed with an oil groove 375 that has a first end opening into the second opening 335 at a location between the outer second bearing 208 and the oil seal 339 in the axial direction, and a second end opening into the gearbox 300.

Due to this configuration, oil sent outward in the axial direction past the outer second bearing 208 can be returned into the gearbox 300, and an excessive oil pressure on the oil seal 339 can be effectively prevented.

Hereinafter, a modification of the support structure for the second shaft 106 will now be described.

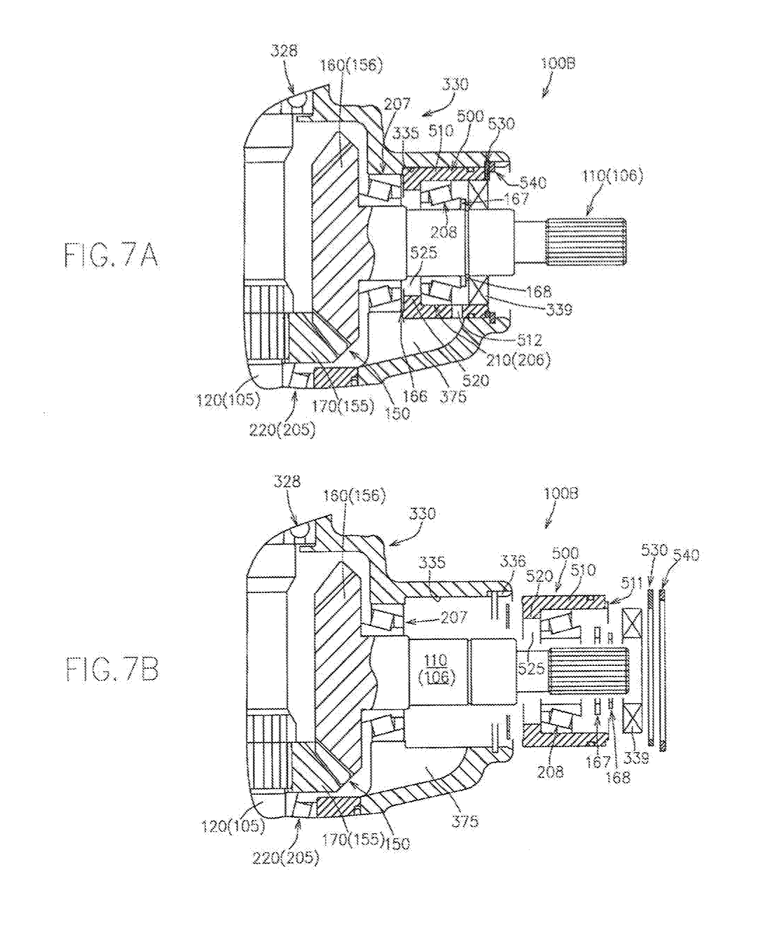

FIGS. 7A and 7B respectively show a partial vertical cross-sectional view and a partial exploded vertical cross-sectional view of a bevel gear power transmission structure 100B of a first modification.

In FIGS. 7A and 7B, the same components as those in the above embodiment are given the same reference numbers.

In the first modification, the second bevel gear 156 is integrated with the second shaft 106 into a single body as shown in FIGS. 7A and 7B.

With the second bevel gear 156 being placed in the inner space of the gearbox, the second shaft 106 is directly or indirectly supported by the third wall 330 via the second bearing 206 so as to be rotatable around the axis and movable in the axial direction.

In the first modification, the inner second bearing 207 rotatably supports the second shaft 106 in the second opening 335 and, on the other hand, the outer second bearing 208 rotatably supports the second shaft 106 in the second collar 500 detachably attached to the second opening 335.

That is, the second collar 500 is detachably disposed in a portion of the second opening 335 more toward the outside in the axial direction of the second shaft 106 than the inner second bearing 207 is.

The second collar 500 has a cylindrical part 510 having an outer circumferential surface in contact with the inner circumferential surface of the second opening 335 and an end wall 520 extending radially inward from the inner end in the axial direction of the cylindrical part 510 while leaving an opening 525 through which the second shaft 106 is disposed. The outer second bearing 208 is inserted into the cylindrical part 510 from the outer side in the axial direction of the cylindrical part 510.

In this configuration, the inner second bearing 207 is placed such that the inner end surface in the axial direction of the inner ring disposed around the second shaft 106 is in contact with the back surface of the second bevel gear 156 and that the outer end surface in the axial direction of the outer ring surrounding the inner ring via rolling elements is in contact with the end wall 520 of the collar 500 via an inner shim 166.

On the other hand, the outer second bearing 208 is placed such that the outer end surface in the axial direction of the inner ring disposed around the second shaft 106 is in contact, with a retaining ring 168 via an outer shim 167 and that the inner end surface in the axial direction of the outer ring surrounding the inner ring via roiling elements is in contact with the end wall 520 of the collar 500.

In the first modification, the position in the axial direction of the second bevel gear 156 is adjusted by the thickness of the inner shim 166.

In the first modification, the second bevel gear 156 and the second shaft 106 are integrated into a single body as described above. In this configuration, when the thickness of the inner shim 166 is changed, the thickness of the outer shim 167 is also changed accordingly.

That is, when the inner shim 166 having a larger thickness is used to position the second bevel gear 156 more inward in the axial direction of the second shaft 106, the outer shim 167 having a smaller thickness is used.

The rotation of the second collar 500 around the axis is prevented by the following configuration.

That is, the outer end surface in the axial direction of the cylindrical part 510 of the second collar 500 has depressed second-collar-side engagement parts 511 depressed radially inward with reference to the axis of the second shaft 106.

On the other hand, a region of the second opening 335 relative to the axial direction, from a place corresponding to the second-collar-side engagement, parts 511 of the second collar 500 to the outer end surface in the axial direction, has depressed second-opening-side engagement parts 336 depressed radially outward with reference to the axis of the second shaft 106.

In this configuration, an engagement member 530 having engagement parts respectively engaged with the second-collar-side engagement parts 511 and the second-opening-side engagement parts 336, and a retaining ring 540 for preventing the engagement member 530 from being separated, are provided.

In the first modification, as shown in FIG. 7A, the cylindrical part 510 has a communicating hole 512 that allows the oil groove 375 to be in communication with a portion of the inner space of the cylindrical part 510 more toward the outside in the axial direction than the outer second bearing 208 is, and, thereby, oil sent outward in the axial direction past the outer second, bearing 208 is returned into the gearbox 300 via the communicating hole 512 and the oil groove 375, and an excessive oil pressure on the oil seal 339 can be effectively prevented.

Next, another modification of the support structure for the second shaft 106 will now be described.

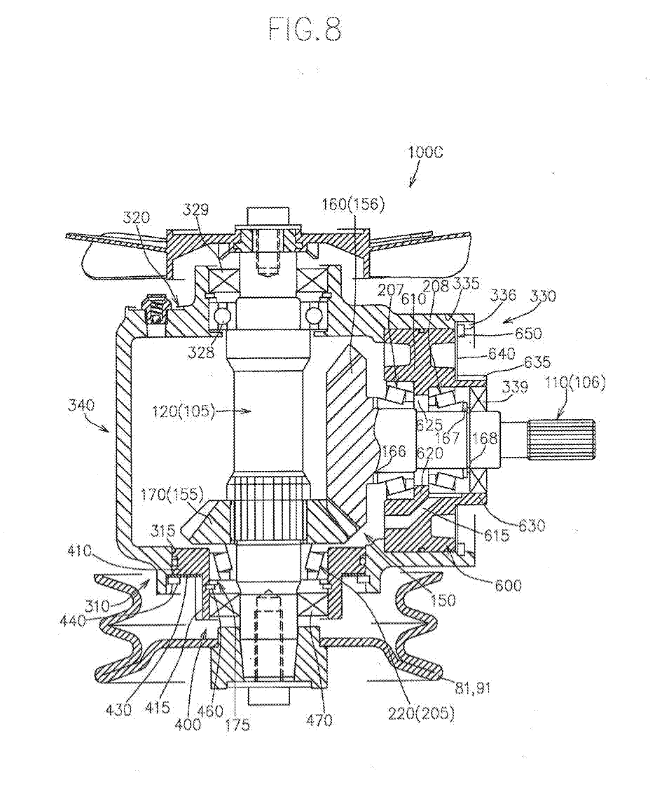

FIG. 8 shows a vertical cross-sectional view of a bevel gear power transmission structure 100C according to the second modification.

In FIG. 8, the same components as those in the above embodiment and the first modification are given the same reference numbers.

In the above embodiment and the first modification, the second opening 335 formed in the third wall 330 has a smaller diameter than the second bevel gear 156, and the second bevel gear 156 is inserted into the gearbox 300 through the access opening 545 formed in the fourth wall 340.

On the other hand, in the second modification, the second opening 335 formed in the third wall 330 has a larger diameter than the second bevel gear 156, and a second collar 600 is disposed in the second opening 335.

The second collar 600 is configured to be detachably attached to the second opening 335 while retaining the inner second bearing 207 and the outer second bearing 208.

Specifically, the second collar 600 has a cylindrical part 610 having an outer circumferential surface in contact with the inner circumferential surface of the second opening 335 and an inner circumferential surface in contact with the outer circumferential surfaces of the outer rings of the inner second bearing 207 and the outer second bearing 208 and a flange 620 extending radially inward from an intermediate part in the axial direction of the inner circumferential surface in the cylindrical part 610 so as to leave art opening 625 through which the second shaft 106 is disposed.

The inner second bearing 207 is placed such that the inner end surface in the axial direction of the inner ring disposed around the second shaft 106 is in contact with the back surface of the second bevel gear 156 via the inner shim 166 and that the outer end surface in the axial direction of the outer ring surrounding the inner ring, via rolling elements is in contact with the flange 620.

The outer second bearing 208 is placed such that the outer end surface in the axial direction of the inner ring disposed around the second shaft 106 is in contact with the retaining ring 168 via the outer shim 167 and that the inner end surface in the axial direction of the outer ring surrounding the inner ring via rolling elements is in contact with the flange 620.

In the second modification, the position in the axial direction of the second bevel gear 156 is adjusted by the thickness of the inner shim 166.

In the second modification as well, the second bevel gear 156 and the second shaft 106 are integrated into a single body as in the first modification. Thus, when the thickness of the inner shim 166 is changed, the thickness of the outer shim 167 is also changed accordingly.

That is, when the inner shim 166 having a larger thickness is used to position the second bevel gear 156 more inward in the axial direction of the second shaft 106, the outer shim 167 having a smaller thickness is used.

In the second modification, the outer end surface in the axial direction of the cylindrical part 610 of the second collar 600 forms an engagement surface in the second opening 335 that faces outward in the axial direction of the second shaft 106; a second-collar retaining ring 650 is detachably attached to the second opening 335 so as to be directly or indirectly engaged with the engagement surface; and the second collar 600 is thereby prevented from being separated from the second opening 335 by the second-collar retaining ring 650.

Furthermore, in the second modification, the rotation of the second collar 600 around the axis is prevented by the following configuration.

That is, the second collar 600 has a small-diameter part 630 that has a diameter reduced from the outer end of the cylindrical part 610 in the axial direction of the second shaft 106 with the end surface being interposed between the cylindrical part 610 and the small-diameter part 630 and that extends outward in the axial direction.

The outer circumferential surface of the small-diameter part 630 has depressed or projecting second-collar-side engagement parts 635 depressed radially inward or projecting radially outward with reference to the axis of the second shaft 106.

As shown in FIG. 8, in the second modification, the second-collar-side engagement parts 635 are depressed.

On the other hand, portions of the second opening 335 corresponding to the small-diameter parts 630 in the axial direct ion of the second shaft 106 have depressed or projecting second-opening-side engagement parts 336 depressed radially outward or projecting radially inward with reference to the axis of the second shaft 106.

As shown in FIG. S, in the second modification, the second-opening-side engagement parts 336 are depressed.

In the second modification, an engagement member 640 including engagement parts respectively engaged with the second-collar-side engagement parts 635 and the second-opening-side engagement parts 336 is interposed between the engagement surface of the cylindrical part 610 of the second collar 600 and the second-collar retaining ring 650 and, thereby, the rotation of the second collar 600 around the axis is prevented.

Moreover, in the second modification, as shown in FIG. 8, the cylindrical part 610 of the second collar 600 has an oil passage 615 that has a first end opening into a portion of the inner space of the cylindrical part 610 more toward the outside in the axial direction than the outer second bearing 208 is, and a second end opening into the inner space of the gearbox 300 and, thereby, oil sent outward in the axial direction past the outer second bearing 208 is returned into the gearbox 300, and an excessive oil pressure on the oil seal 339 can be effectively presented.

What is claimed is:

1. A bevel gear power transmission structure for transmitting rotative power from a drive shaft to a driven shaft, comprising the drive shaft, a gearbox supporting the drive shaft via a drive-side bearing so as to be rotatable around an axis, a drive-side bevel gear supported by the drive shaft so as to be placed in an inner space of the gearbox, the driven shaft supported by the gearbox via a driven-side bearing so as to be perpendicular to the drive shaft and rotatable around an axis, and a driven-side bevel gear supported by the driven shaft so as to mesh with the drive-side bevel gear in the inner space of the gearbox, wherein
a first wall of the gear box, supporting a first shaft that is one of the drive shaft and the driven shaft, has a first opening having a larger diameter than a first bevel gear that is one of the drive-side bevel gear and the driven-side bevel gear and that is supported by the first shaft,
a hollow first collar retaining a first bearing that is one of the drive-side bearing and the driven-side bearing and that supports the first shaft is detachably disposed in the first opening, and
the first collar has an outer circumferential surface in contact with an inner circumferential surface of the first opening, an inner circumferential surface in contact with an outer ring of the first bearing, and an engagement surface facing outward in an axial direction of the first shaft in the first opening; the engagement surface is directly or indirectly engaged with a first-collar retaining ring detachably attached to the inner circumferential surface of the first opening; and the first collar is thereby prevented from being separated outward from the first opening.

2. The bevel gear power transmission structure according to claim 1, wherein
the first collar has a large-diameter part forming the outer circumferential surface in contact with the inner circumferential surface of the first opening, and a small-diameter part that has a diameter smaller than the large-diameter part with the engagement surface being interposed between the large-diameter part and the small-diameter part and that extends outward in the axial direction of the first shaft.
an outer circumferential surface of the small-diameter part has a depressed or projecting first-collar-side engagement part depressed radially inward or projecting radially outward with reference to an axis of the first shaft,
a portion of the first opening corresponding to the small-diameter part in the axial direction of the first shaft have a depressed or projecting first-opening-side engagement part depressed radially outward or projecting radially inward with reference to the axis of the first shaft, and
an engagement member having engagement parts respectively engaged with the first-collar-side engagement part and the first-opening-side engagement part is interposed between the engagement surface and the first-collar retaining ring.

3. The bevel gear power transmission structure according to claim 1, wherein
the first bevel gear is supported by the first shaft in a relatively non-rotatable manner around the axis and in a movable manner in the axial direction with respect to the first shaft,
an inner ring of the first bearing has an end surface facing inward in the axial direction of the first shaft and directly or indirectly in contact with a back surface of the first bevel gear, and an outer ring of the first bearing has an end surface facing outward in the axial direction of the first shaft and directly or indirectly in contact with a bearing retaining ring detachably attached to the inner circumferential surface of the first collar, and
a shim is interposed at least between the back surface of the first bevel gear and the inner ring of the first bearing or between the outer ring of the first bearing and the bearing retaining ring.

4. The bevel gear power transmission structure according to claim 2, wherein
the first bevel gear is supported by the first shaft in a relatively non-rotatable manner around the axis and in a movable manner in the axial direction with respect to the first shaft,
an inner ring of the first bearing has an end surface facing inward in the axial direction of the first shall and directly or indirectly in contact with a back surface of the first bevel gear, and an outer ring of the first bearing has an end surface facing outward in the axial direction of the first shaft and directly or indirectly in contact with a bearing retaining ring detachably attached to the inner circumferential surface of the first collar, and
a shim is interposed at least between the back surface of the first bevel gear and the inner ring of the first bearing or between the outer ring of the first bearing and the bearing retaining ring.

5. The bevel gear power transmission structure according to claim 1, wherein
the gearbox has the first wall, a second wall facing the first wall, a third wall supporting a second shaft that is the other one of the drive shaft and the driven shaft via a second bearing that is the other one of the drive-side bearing and the driven-side bearing, and a fourth wall facing the third wall,
the first shaft is supported at two portions that includes a first portion supported by the first wall via the first bearing and a second portion supported by the second wall via a bearing,
the third wall has a second opening through which the second shaft is disposed via the second bearing, and
the fourth wall has an access opening having a larger diameter than a second bevel gear that is the other one of the drive-side bevel gear and the driven-side bevel gear and that is supported by the second shaft, and the access opening is blocked by a cap detachably attached thereto.

6. The bevel gear power transmission structure according to claim 2, wherein
the gearbox has the first wall, a second wall facing the first wall, a third wall supporting a second shaft that is the other one of the drive shaft and the driven shaft via a second bearing that is the other one of the drive-side bearing and the driven-side bearing, and a fourth wall facing the third wall,
the first shaft is supported at two portions that includes a first portion supported by the first wall via the first bearing and a second portion supported by the second wall via a bearing,
the third wall has a second opening through which the second shaft is disposed via the second bearing, and
the fourth wall has an access opening having a larger diameter than a second bevel gear that is the other one of the drive-side bevel gear and the driven-side bevel gear and that is supported by the second shaft, and the access opening is blocked by a cap detachably attached thereto.

7. The bevel gear power transmission structure according to claim 3, wherein
the gearbox has the first wall, a second wall facing the first wall, a third wall supporting a second shaft that is the other one of the drive shaft and the driven shaft via a second bearing that is the other one of the drive-side bearing and the driven-side bearing, and a fourth wall facing the third wall,
the first shaft is supported at two portions that includes a first portion supported by the first wall via the first bearing and a second portion supported by the second wall via a bearing,
the third wall has a second opening through which the second shaft is disposed via the second bearing, and
the fourth wall has an access opening having a larger diameter than a second bevel gear that is the other one of the drive-side bevel gear and the driven-side bevel gear and that is supported by the second shaft, and the access opening is blocked by a cap detachably attached thereto.

8. The bevel gear power transmission structure according to claim 4, wherein
the gearbox has the first wall, a second wall facing the first wall, a third wall supporting a second shaft that is the other one of the drive shaft and the drivers shaft via a second bearing that is the other one of the drive-side bearing and the driven-side bearing, and a fourth wall facing the third wall,
the first shaft is supported at two portions that includes a first portion supported by the first wall via the first bearing and a second portion supported by the second wall via a bearing,
the third wall has a second opening through which the second shaft is disposed via the second bearing, and
the fourth wall has an access opening having a larger diameter than a second bevel gear that is the other one of the drive-side bevel gear and the driven-side bevel gear and that is supported by the second shaft, and the access opening is blocked by a cap detachably attached thereto.

9. The bevel gear power transmission structure according to claim 1, wherein
the gearbox has the first wall, a second wall facing the first wall, a third wall supporting a second shaft that is the other one of the drive shaft and the driven shaft via a second bearing that is the other one of the drive-side bearing and the driven-side bearing, and a fourth wall facing the third wall,
the first shaft is supported at two portions that includes a first portion supported by the first wall via the first bearing and a second portion supported by the second wall via a bearing,
the third wall has a second opening having a larger diameter titan a second bevel gear that is the other one of the drive-side bevel gear and the driven-side bevel gear and that is supported by the second shaft,
a hollow second collar retaining the second bearing is detachably disposed in the second opening, and
the second collar has an outer circumferential surface in contact with an inner circumferential surface of the second opening, an inner circumferential surface in contact with an outer ring of the second bearing, and an engagement surface lacing outward in an axial direction of the second shaft in the second opening; and the second collar is prevented from being separated outward from the second opening by a second-collar retaining ring detachably attached to the second opening so as to be directly or indirectly engaged with the engagement surface.

10. The bevel gear power transmission structure according to claim 2, wherein
the gearbox has the first wall, a second wall facing the first wall, a third wall supporting a second shaft that is the other one of the drive shaft and the driven shaft via a second bearing that is the other one of the drive-side bearing and the driven-side bearing, and a fourth wall facing the third wall,
the first shaft is supported at two portions that includes a first portion supported by the first wall via the first bearing and a second portion supported by the second wall via a bearing,
the third wall has a second opening having a larger diameter than a second bevel gear that is the other one of the drive-side bevel gear and the driven-side bevel gear and that is supported by the second shaft,
a hollow second collar retaining the second bearing is detachably disposed in the second opening, and
the second collar has an outer circumferential surface in contact with an inner circumferential surface of the second opening, an inner circumferential surface in contact with an outer ring of the second bearing, and an engagement surface facing outward in an axial direction of the second shaft in the second opening; and the second collar is prevented from being separated outward from the second opening by a second-collar retaining ring detachably attached to the second opening so as to be directly or indirectly engaged with the engagement surface.

11. The bevel gear power transmission structure according to claim 3, wherein
the gearbox has the first wall, a second wall facing the first wall, a third wall supporting a second shaft that is the other one of the drive shaft and the driven shaft via a second bearing that is the other one of the drive-side bearing and the driven-side bearing, and a fourth wall facing the third wall,
the first shaft is supported at two portions that includes a first portion supported by the first wall via the first bearing and a second portion supported by the second wall via a bearing,
the third wall has a second opening having a larger diameter than a second bevel gear that is the other one of the drive-side bevel gear and the driven-side bevel gear and that is supported by the second shaft,
a hollow second collar retaining the second bearing is detachably disposed in the second opening, and
the second collar has an outer circumferential surface in contact with an inner circumferential surface of the second opening, an inner circumferential surface in contact with an outer ring of the second bearing, and an engagement surface facing outward in an axial direction of the second shaft in the second opening; and the second collar is prevented from being separated outward from the second opening by a second-collar retaining ring detachably attached to the second opening so as to be directly or indirectly engaged with the engagement surface.

12. The bevel gear power transmission structure according to claim 4, wherein
the gearbox has the first wall, a second wall facing the first wall, a third wall supporting a second shaft that is the other one of the drive shaft and the driven shaft via a second bearing that is the other one of the drive-side bearing and the drivers-side bearing, and a fourth wall facing the third wall,
the first shall is supported at two portions that includes a first portion supported by the first wall via the first bearing and a second portion supported by the second wall via a bearing,
the third wall has a second opening having a larger diameter than a second bevel gear that is the other one of the drive-side bevel gear and the driven-side bevel gear and that is supported by the second shaft,
a hollow second collar retaining the second bearing is detachably disposed in the second opening, and
the second collar has an outer circumferential surface in contact with an inner circumferential surface of the second opening, an inner circumferential surface in contact with an outer ring of the second bearing, and an engagement surface lacing outward in an axial direction of the second shaft in the second opening; and the second collar is prevented from being separated outward from the second opening by a second-collar retaining ring detachably attached to the second opening so as to be directly or indirectly engaged with the engagement surface.
